(19) United States
(12) Patent Application Publication
(10) Pub. No.: US 2026/0188654 A1
(43) Pub. Date: Jul. 2, 2026

(54) CATHODE COMPOSITION FOR LI-ION BATTERY

(71) Applicant: Arkema France, Colombes (FR)

(72) Inventors: Gregory SCHMIDT, Pierre-Benite Cedex (FR); Cyrille MATHIEU, Pierre-Benite Cedex (FR)

(21) Appl. No.: 18/717,513

(22) PCT Filed: Dec. 13, 2022
(86) PCT No.: PCT/FR2022/052336

§ 371 Date: Jun. 7, 2024

(30) Foreign Application Priority Data
Dec. 17, 2021 (FR) FR21.13775

(51) Int. Cl. H01M 4/36; H01M 4/02; H01M 4/58; H01M 4/62; H01M 10/0525

(52) U.S. Cl. CPC H01M 4/366; H01M 4/5825; H01M 4/623; H01M 4/625; H01M 10/0525; H01M 2004/021; H01M 2004/028

(57) ABSTRACT

The present invention relates generally to the field of the storage of electrical energy in rechargeable storage batteries of Li-ion type. More specifically, the invention relates to a cathode composition for a Li-ion battery. The invention also relates to a process for the manufacture of such a cathode composition and also to the Li-ion storage batteries comprising such a cathode.

### FIELD OF THE INVENTION

The present invention relates generally to the field of the storage of electrical energy in rechargeable storage batteries of Li-ion type. More specifically, the invention relates to a cathode composition for a Li-ion battery. The invention also relates to a process for the manufacture of such a cathode composition and also to the Li-ion storage batteries comprising such a cathode.

### TECHNICAL BACKGROUND

A lithium storage battery can be used as power supply for a variety of electronic devices ranging from mobile phones, laptops and small domestic electronic devices to vehicles and to high-capacity energy storage devices and others, and the demand for lithium storage batteries is ceaselessly growing.

For the large-scale development of electric vehicles, a decrease in the manufacturing costs of the batteries is essential, and one of the options envisaged is the use of cobalt-free low-cost active substances. Furthermore, the increase in the weight energy density of the batteries of electric vehicles remains a major challenge for the mass adoption of this technology. The increase in the thickness of the electrodes and the decrease in the size of the particles of active substances would make it possible to achieve these objectives in terms of cost and of energy density.

The increase in the thickness of the electrodes involves improving the electrode/collector adhesion. The decrease in the size of the particles involves an increase in viscosity of the ink, preventing it from being used in a conventional deposition process for the electrode preparation.

The publication by M. Singh et al. in Journal of The Electrochemical Society, 162 (7), A1196-A1201 (2015), has shown that the layers of thicker electrodes (320 μm) for lithium-ion cells exhibit a favourable electrode/current collector ratio per volume of battery and make it possible to reduce the manufacturing costs of the cells. However, while this approach of thick electrodes might be sufficient for some stationary energy storage applications, it would not be suitable for the manufacture of electric vehicles.

Current industrial equipment for cathode coatings impose a window of processability with regard to the viscosity of the ink to be deposited on the current collector. This is because an ink having a viscosity of between 2000 and 8000 mPa·s @ 10 s⁻¹ is an ink which can be easily applied to a current collector. Below 2000 mPa·s, a relaxation of the ink is observed during the application of the coating and the drying which brings about a huge variation in the thickness and in the weight deposited. Above 8000 mPa·s, the ink is no longer deposited uniformly.

Furthermore, in the battery industry, the rheological stability of the ink during its storage is a critical parameter for the optimization of productivity. This is because the ink has to retain its abovementioned rheological properties for up to 72 h of storage.

Furthermore, the roll-to-roll processes for the industrial manufacture of electrodes involve a minimum value of adhesion of the dry substance deposited on the current collector. For good mechanical strength of the electrode, this adhesion value obtained by a 180° peel test has to be greater than 20 N/m.

There still exists a need to develop binder compositions for cathodes which make it possible to increase the weight energy density in a Li-ion battery for an application in electric vehicles, while retaining good mechanical and adhesion properties.

Surprisingly, the inventors have discovered the importance of a physical parameter of the polymer binder used in the manufacture of cathodes on the rheological and mechanical performance qualities of the cathodes obtained. This is because, on cathode active materials coated with carbon, the present invention demonstrates that an initial haze of the fluoropolymer binder of between 45 and 390 NTU makes it possible to be in a processability and mechanical strength optimum of the final electrodes.

### SUMMARY OF THE INVENTION

The technical solution proposed by the present invention is to provide a cathode composition for a battery, said composition comprising a fluoropolymer binder, an electrode active substance and a conductive material.

Characteristically, said fluoropolymer binder exhibits an initial haze of the polymer binder of between 45 and 390 NTU, preferably of between 100 and 300 NTU.

Characteristically, said electrode active substance is coated with a carbon layer.

The invention is also targeted at providing a process for the manufacture of the cathode compositions employing active materials coated with carbon, and a fluoropolymer binder exhibiting an initial haze of between 45 and 390 NTU at a concentration of 7% in NMP.

Another subject-matter of the invention is a Li-ion storage battery comprising a negative electrode, a positive electrode and a (liquid or solid) electrolyte, in which the cathode is as described above.

The present invention makes it possible to overcome the disadvantages of the state of the art. It provides a cathode composition for a battery making it possible to fulfil all the specific features required to manufacture and obtain cathodes of high performance, as regards mechanical properties and properties of adhesion to the current collector, this being the case whatever the nature of the fluoropolymer binder used, as long as its haze is between 45 and 390 NTU at a concentration of 7% in NMP.

### DESCRIPTION OF EMBODIMENTS OF THE INVENTION

The invention is now described in more detail and in a non-limiting way in the description which follows.

According to a first aspect, the invention relates to a cathode composition for a battery, said composition comprising:
a fluoropolymer binder (component A),
an electrode active substance (component B), and
a conductive material (component C),
   in which said polymer binder exhibits an initial haze of the polymer binder of between 45 and 390 NTU, preferably of between 100 and 300 NTU, and said electrode active substance is coated with a carbon layer.

According to various embodiments, said electrode composition comprises the following features, if appropriate combined. The contents indicated are expressed by weight, unless otherwise indicated.

### Component A

The polymer binder used in the invention is a polymer based on vinylidene difluoride and is denoted generically by the abbreviation PVDF.

According to one embodiment, the PVDF is a poly(vinylidene fluoride) homopolymer or a mixture of vinylidene fluoride homopolymers.

According to one embodiment, the PVDF is a poly(vinylidene fluoride) homopolymer or a copolymer of vinylidene difluoride with at least one comonomer compatible with vinylidene difluoride.

According to one embodiment, the PVDF is semi-crystalline.

The comonomers compatible with vinylidene difluoride can be halogenated (fluorinated, chlorinated or brominated) or non-halogenated.

Examples of appropriate fluorinated comonomers are: vinyl fluoride, tetrafluoroethylene, hexafluoropropylene, trifluoropropenes and in particular 3,3,3-trifluoropropene, tetrafluoropropenes and in particular 2,3,3,3-tetrafluoropropene or 1,3,3,3-tetrafluoropropene, hexafluoroisobutylene, perfluorobutylethylene, pentafluoropropenes and in particular 1,1,3,3,3-pentafluoropropene or 1,2,3,3,3-pentafluoropropene, perfluoroalkyl vinyl ethers and in particular those of general formula Rf—O—CF—CF₂, Rf being an alkyl group, preferably a C₁ to C₄ alkyl group (preferred examples being perfluoropropyl vinyl ether and perfluoromethyl vinyl ether).

The fluorinated comonomer can comprise a chlorine or bromine atom. It can in particular be chosen from bromotrifluoroethylene, chlorofluoroethylene, chlorotrifluoroethylene and chlorotrifluoropropene. Chlorofluoroethylene can denote either 1-chloro-1-fluoroethylene or 1-chloro-2-fluoroethylene. The 1-chloro-1-fluoroethylene isomer is preferred. Chlorotrifluoropropene is preferably 1-chloro-3,3,3-trifluoropropene or 2-chloro-3,3,3-trifluoropropene.

The VDF copolymer can also comprise non-halogenated monomers, such as ethylene, and/or acrylic or methacrylic comonomers.

The fluoropolymer preferably contains at least 50 mol % of vinylidene difluoride.

According to one embodiment, the PVDF is a copolymer of vinylidene fluoride (VDF) and of hexafluoropropylene (HFP) (P(VDF-HFP)), having a percentage by weight of hexafluoropropylene monomer units of from 2% to 23%, preferably from 4% to 15%, by weight, with respect to the weight of the copolymer.

According to one embodiment, the PVDF is a mixture of a poly(vinylidene fluoride) homopolymer and of a VDF-HFP copolymer.

According to one embodiment, the PVDF is a copolymer of vinylidene fluoride and of tetrafluoroethylene (TFE).

According to one embodiment, the PVDF is a copolymer of vinylidene fluoride and of chlorotrifluoroethylene (CTFE).

According to one embodiment, the PVDF is a VDF-TFE-HFP terpolymer. According to one embodiment, the PVDF is a VDF-TrFE-TFE terpolymer (TrFE being trifluoroethylene). In these terpolymers, the content by weight of VDF is at least 10%, the comonomers being present in variable proportions.

According to one embodiment, the PVDF comprises monomer units carrying at least one of the following functions: carboxylic acid, carboxylic acid anhydride, carboxylic acid ester, epoxy (such as glycidyl), amide, hydroxyl, carbonyl, mercapto, sulfide, oxazoline, phenolic, ester, ether, siloxane, sulfonic, sulfuric, phosphoric or phosphonic groups. The function is introduced by a chemical reaction which can be grafting or a copolymerization of the fluorinated monomer with a monomer carrying at least one of said functional groups and a vinyl function capable of copolymerizing with the fluorinated monomer, according to techniques well known to a person skilled in the art.

According to one embodiment, the functional group carries a carboxylic acid function which is a group of (meth)acrylic acid type chosen from acrylic acid, methacrylic acid, hydroxyethyl (meth)acrylate, hydroxypropyl (meth)acrylate and hydroxyethylhexyl (meth)acrylate.

According to one embodiment, the units carrying the carboxylic acid function additionally comprise a heteroatom chosen from oxygen, sulfur, nitrogen and phosphorus.

According to one embodiment, the functionality is introduced by means of the transfer agent used during the synthesis process. The transfer agent is a polymer with a molar mass of less than or equal to 20 000 g/mol carrying functional groups chosen from the following groups: carboxylic acid, carboxylic acid anhydride, carboxylic acid ester, epoxy (such as glycidyl), amide, hydroxyl, carbonyl, mercapto, sulfide, oxazoline, phenolic, ester, ether, siloxane, sulfonic, sulfuric, phosphoric or phosphonic groups. An example of transfer agent of this type is acrylic acid oligomers.

The content of functional groups in the PVDF is at least 0.01 mol %, preferably at least 0.1 mol %, and at most 15 mol %, preferably at most 10 mol %.

The PVDF preferably has a high molecular weight. The term “high molecular weight”, as used here, is understood to mean a PVDF having a melt viscosity of greater than 100 Pa·s, preferably of greater than 500 Pa·s, more preferably of greater than 1000 Pa·s, advantageously of greater than 2000 Pa·s. The viscosity is measured at 232° C., at a shear gradient of 100 s⁻¹, using a capillary rheometer or a parallel-plate rheometer, according to Standard ASTM D3825. The two methods give similar results.

The PVDF homopolymers and the VDF copolymers used in the invention can be obtained by known polymerization methods, such as emulsion polymerization.

According to one embodiment, they are prepared by an emulsion polymerization process in the absence of a fluorinated surface-active agent.

The polymerization of the PVDF results in a latex generally having a solids content of from 10% to 60% by weight, preferably from 10% to 50%, and having a weight-average particle size of less than 1 micrometre, preferably of less than 1000 nm, preferably of less than 800 nm and more preferably of less than 600 nm. The weight-average size of the particles is generally at least 10 nm, preferably at least 50 nm, and advantageously the average size is within the range from 100 to 400 nm. The polymer particles can form agglomerates, referred to as secondary particles, the weight-average size of which is less than 5000 μm, preferably less than 1000 μm, advantageously between 1 and 80 micrometres and preferably from 2 to 50 micrometres. The agglomerates can break up into discrete particles during the formulation and the application to a substrate.

According to some embodiments, the PVDF homopolymer and the VDF copolymers are composed of biobased VDF. The term “biobased” means “resulting from biomass”. This makes it possible to improve the ecological footprint of the membrane. Biobased VDF can be characterized by a content of renewable carbon, that is to say of carbon of natural origin originating from a biomaterial or from biomass, of at least 1 atom %, as determined by the content of 14° C. according to Standard NF EN 16640. The term “renewable carbon” indicates that the carbon is of natural origin and originates from a biomaterial (or from biomass), as indicated below. According to some embodiments, the biocarbon content of the VDF can be greater than 5%, preferably greater than 10%, preferably greater than 25%, preferably greater than or equal to 33%, preferably greater than 50%, preferably greater than or equal to 66%, preferably greater than 75%, preferably greater than 90%, preferably greater than 95%, preferably greater than 98%, preferably greater than 99%, advantageously equal to 100%.

Characteristically, said fluoropolymer binder exhibits an initial haze of between 45 and 390 NTU at a concentration of 7% in NMP, preferably of between 100 and 300 NTU at a concentration of 7% in NMP. The acronym “NTU” means nephelometric turbidity units.

The haze value is measured using a turbidimeter calibrated beforehand with several standard solutions of Stablcal® formazine ranging from 10 to 800 NTU. This measurement is carried out on a solution of polymer binder dissolved in N-methylpyrrolidone (NMP) at a concentration by weight of 77.5 g/l and at a temperature of 25° C., which is equivalent to a concentration of 7% in NMP (dry matter).

The polymer binder is dissolved in NMP by any method known to a person skilled in the art, such as pseudo-planetary mixer, planetary mixer, roll-type mixer, disperser and conventional stirring. The term “initial” refers to the state of the fluoropolymer dissolved in the NMP.

### Component B

The expression “active substance coated with carbon” is understood to mean any inorganic lithium insertion compound covered with a graphitic layer ranging from 5 nm to 1 μm, as measured by transmission electron microscopy.

The size of the elementary particles of active substance is between 100 nm and 5 μm, as measured by laser particle size analysis.

According to one embodiment, the active substance in the positive electrode is chosen from manganese dioxide (MnO₂), iron oxide, copper oxide, nickel oxide, lithium/manganese composite oxides (for example LiₓMn₂O₄ or LiₓMnO₂), lithium/nickel composite oxides (for example LiₓNiO₂), lithium/cobalt composite oxides (for example LiₓCoO₂), lithium/nickel/cobalt composite oxides (for example LiNi_{1-y}Co_{y}O₂), lithium/nickel/cobalt/manganese composite oxides (for example LiNiₓMn_{y}Co_{z}O₂ with X+y+z=1), lithium-enriched lithium/nickel/cobalt/manganese composite oxides (for example Li₁₊ₓ(NiₓMn_{y}Co_{z})₁₋ₓO₂), lithium/transition metal composite oxides, lithium/manganese/nickel composite oxides of spinel structure (for example LiₓMn_{2-y}Ni_{y}O₄), high-voltage nickel/manganese composite oxides (for example LiMn_{1.5}Ni_{0.5}—XₓO₄ (X being chosen from: Al, Fe, Cr, Co, Rh and Nd with 0<x<0.1), vanadium oxides, oxides of sulfur of S₈ type and their mixtures.

According to one embodiment, said active substance does not contain cobalt; it is chosen from LiFePO₄, LiMnPO₄, LiFeₓMn_{y}PO₄, LiFePO₄F, LiMnPO₄F and LiFeₓMn_{y}PO₄F where x+y=1.

### Component C

The electron-conducting substance is chosen from carbon blacks, graphites, which are natural or synthetic, carbon fibres, carbon nanotubes, metal fibres and powders, and conductive metal oxides. Preferentially, they are chosen from carbon blacks, graphites, which are natural or synthetic, carbon fibres and carbon nanotubes.

The composition by weight of the cathode coating according to the invention is:
Component A with a ratio by weight of between 80% and 99%;
Component B with a ratio by weight of between 1% and 10%;
Component C with a ratio by weight of between 1% and 10%;
   the sum of these ratios being 100%.

The invention also relates to a process for the manufacture of the cathode compositions employing active materials coated with carbon, a conductive material and a fluoropolymer binder, said process comprising the following stages:
preparation of a polymer binder solution by dissolution of component A in N-methylpyrrolidone (NMP) at a dry matter content of from 2% to 20%, preferably of from 2% to 15%, advantageously of from 4% to 14%;
addition of component B and of component C to said solution of polymer binder, and mixing to obtain an electrode formulation (also referred to as ink) which can be applied to a metal support.

The invention also relates to a process for the manufacture of a Li-ion battery positive electrode comprising the following stages:
providing an electrode formulation which can be applied to a metal support,
deposition of said electrode formulation on the metal substrate,
the consolidation of said electrode by a heat treatment (application of a temperature ranging up to 50° C. above the melting point of the polymer, without mechanical pressure) and/or a thermomechanical treatment, such as calendering.

According to one embodiment, a cathode was manufactured by following the following stages: a 7% by weight solution of polymer binder in N-methyl-2-pyrrolidone is prepared until the polymer binder has completely dissolved. Super P C65 carbon black (supplier Timcal) is then added to this solution. The solution is mixed using a mechanical stirrer. The active material coated with carbon is then added. An ink is obtained which contains, by weight, 94 parts of active materials coated with carbon, 3 parts of carbon black and 3 parts of binder per 100 parts of the active materials coated with carbon/carbon black/binder mixture. The ink obtained is deposited on an aluminium sheet so as to have a wet thickness of 200 μm. The NMP is then evaporated by heating the coated sheet at 90° C. for 15 minutes and then at 150° C. for 30 minutes. A coating having a thickness of 70±10 μm is thus obtained.

The metal supports of the electrodes are generally made of aluminium for the cathode. The metal supports can be surface-treated and have a conductive primer with a thickness of 5 μm or more. The supports can also be woven or non-woven fabrics made of carbon fibre.

Another subject-matter of the invention is a Li-ion storage battery comprising a negative electrode, a positive electrode and an electrolyte, in which the cathode is as described above.

### EXAMPLES

The following examples illustrate the scope of the invention in a non-limiting manner.

Homopolymer 1: Vinylidene fluoride homopolymer, characterized by a viscosity in solution of 4000 mPa·s in NMP.
Homopolymer 2: Vinylidene fluoride homopolymer, characterized by a viscosity in solution of 5000 mPa·s in NMP.
Homopolymer 3: Vinylidene fluoride homopolymer, characterized by a viscosity in solution of 2000 mPa·s in NMP.
Homopolymer 4: Vinylidene fluoride homopolymer, characterized by a viscosity in solution of 11 000 mPa·s in NMP.
Homopolymer 5: Vinylidene fluoride homopolymer, characterized by a viscosity in solution of 10 000 mPa·s in NMP.
Functional copolymer 1: Copolymer of vinylidene fluoride and of acrylic acid, characterized by a viscosity in solution of 6000 mPa·s in NMP.
Functional copolymer 2: Copolymer of vinylidene fluoride and of acrylic acid, characterized by a viscosity in solution of 2000 mPa·s in NMP.
For all these products, the dry matter content is 8%.

### Measurement of the Solution Viscosity of the Polymer Binder Dissolved in NMP:

The viscosity measurements are carried out with a Brookfield DV2T viscometer equipped with the SC4 chamber and with the 25 spindle; the temperature is regulated with a Huber bath at 25° C.

### Measurement of the Haze

The haze of the polymer binder is measured by dissolving the polymer in N-methylpyrrolidone (NMP) at a concentration by weight of 77.5 g/l and at a temperature of 25° C.
The haze value is determined via a Hach 2100 Q turbidimeter, calibrated beforehand using several standard solutions of Stablcal formazine ranging from 10 to 800 NTU.

### Measurement of the Adhesion

The adhesion between the layer formed of the active materials coated with carbon/carbon black/binder mixture and the aluminium sheet is measured. To do this, a strip with a width of 25 mm is cut out. This strip is subsequently adhesively bonded to a stiff aluminium plate using a double-sided adhesive, the adhesive being deposited on the side of the active materials coated with carbon/carbon black/binder coating. The peel test is carried out using a dynamometer from Instron of 34SC1 type by fixing, in one jaw, the stiff aluminium plate and, in the other jaw, the flexible aluminium sheet on which the deposition was carried out. In this configuration, the peel angle is 180°. The rate of displacement of the jaws is set at 100 mm/min.
Measurement of the Viscosity of the Electrode Formulation which can be Applied to a Metal Support
The viscosity of the electrode formulations was measured at 23° C., using a TA HR 10 rheometer. The ink which contains, by weight, 94 parts of active materials coated with carbon, 3 parts of carbon black and 3 parts of binder per 100 parts of the active materials coated with carbon/carbon black/binder mixture is deposited between two parallel plates (diameter of 40 mm) separated by 1 mm (=gap of 1 mm). The values of viscosities are obtained at different shear rates ranging from 0.1 s⁻¹ to 100 s⁻¹. The value of 10 s⁻¹ is taken as comparison between the different formulations.
The performance qualities in terms of adhesion of the cathodes and of viscosity of the electrode formulations having compositions according to the invention (Examples 1, 2 and 7) versus Comparative Examples 3, 4 and 5 are shown in Table 1.

TABLE 1

| | | | Adhesion | Viscosity T = 0 | Viscosity t = 24 H |
|---|---|---|---|---|---|
| No. | Binder | Haze | (N/m) | (mPa · s) @ 10 s⁻¹ | (mPa · s) @ 10 s⁻¹ |
| 1 | Homopolymer 1 | 130 | 22.5 | 3300 | 4470 |
| 2 | Homopolymer 2 | 290 | 43.2 | 5540 | 7450 |
| 3 | Homopolymer 3 | 40 | 17.8 | 1720 | 2590 |
| 4 | Homopolymer 4 | 2 | 38.3 | 7720 | 9310 |
| 5 | Homopolymer 5 | 400 | 46.6 | 6100 | 12 300 |
| 6 | Functional | 3 | 160 | 6700 | 18 000 |
| | copolymer 1 | | | | |
| 7 | Functional | 134 | 40.7 | 2500 | 5220 |
| | copolymer 2 | | | | |

1. A cathode composition for a battery, said cathode composition comprising:
a fluoropolymer binder (component A),
an electrode active substance (component B), and
a conductive material (component C),
wherein said fluoropolymer binder exhibits an initial haze of the fluoropolymer binder of between 45 and 390 NTU, and said electrode active substance is coated with a carbon layer.

2. The cathode composition according to claim 1, wherein said active substance coated with carbon comprises inorganic lithium insertion compounds covered with a graphitic layer, wherein the thickness of the graphitic layer is from 5 nm to 1 μm.

3. The cathode composition according to claim 1, in which wherein said active substance coated with carbon is formed of elementary particles with a size of between 100 nm and 5 μm, as measured by laser particle size analysis.

4. The cathode composition according to claim 1, in which wherein said active substance is selected from the group consisting of manganese dioxide, iron oxide, copper oxide, nickel oxide, lithium-manganese composite oxides, lithium/nickel composite oxides, lithium/cobalt composite oxides, lithium/nickel/cobalt composite oxides, lithium/nickel/cobalt/manganese composite oxides, lithium-enriched lithium/nickel/cobalt/manganese composite oxides, lithium/transition metal composite oxides, lithium/manganese/nickel composite oxides of spinel structure, high-voltage nickel/manganese composite oxides, vanadium oxides, oxides of sulfur of Ss type and their mixtures.

5. The cathode composition according to claim 1, in which wherein said active substance is selected from the group consisting of LiFePO₄, LiMnPO₄, LiFeₓMn_{y}PO₄, LiFePO₄F, LiMnPO₄F and LiFeₓMn_{y}PO₄F where x+y=1.

6. The cathode composition according to claim 1, in which wherein said component A is selected from the group consisting of chosen from poly(vinylidene fluoride) homopolymers and copolymers of vinylidene difluoride with at least one comonomer selected from the group consisting of: vinyl fluoride, tetrafluoroethylene, hexafluoropropylene, 3,3,3-trifluoropropene, 2,3,3,3-tetrafluoropropene, 1,3,3,3-tetrafluoropropene, hexafluoroisobutylene, perfluorobutylethylene, 1,1,3,3,3-pentafluoropropene, 1,2,3,3,3-pentafluoropropene, perfluoropropyl vinyl ether, perfluoromethyl vinyl ether, bromotrifluoroethylene, chlorofluoroethylene, chlorotrifluoroethylene, chlorotrifluoropropene, ethylene and their mixtures.

7. The cathode composition according to claim 6, wherein component A comprises monomer units carrying at least one of the following functionalities: carboxylic acid, carboxylic acid anhydride, carboxylic acid ester, epoxy, amide, hydroxyl, carbonyl, mercapto, sulfide, oxazoline, phenolic, ester, ether, siloxane, sulfonic, sulfuric, phosphoric or phosphonic groups.

8. The cathode composition according to claim 1, wherein component C is selected from the group consisting of from carbon blacks, natural or synthetic graphites, carbon fibres, carbon nanotubes, metal fibres, metal powders, and conductive metal oxides or combinations thereof.

9. The cathode composition according to claim 1, having the following composition by weight:
Component A with a ratio of between 80% and 99%,
Component B with a ratio of between 1% and 5%,
Component C with a ratio of between 1% and 5%,
the sum of these ratios being 100%.

10. A process for the manufacture of the cathode composition of claim 1 comprising the steps of:
dissolving component A in N-methylpyrrolidone (NMP) at a dry matter content of from 2% to 20% to provide a polymer binder solution;
adding component B and component C to said polymer binder solution, and mixing to obtain an electrode formulation.

11. A Li-ion storage battery comprising an anode, a cathode and an electrolyte, said cathode comprising the cathode composition of claim 1.

12. The cathode composition according to claim 1, comprising by weight:
i) Component B of between 1% and 10%, and
ii) Component C of between 1% and 10%,
based on total weight of cathode composition.

13. The cathode composition according to claim 1, wherein the component A is selected from the group consisting of vinylidene fluoride homopolymers and vinylidene fluoride copolymers comprising hexafluoropropylene.
